(19) United States
(12) Patent Application Publication
(10) Pub. No.: US 2006/0219193 A1
(43) Pub. Date: Oct. 5, 2006

(54) Optimized linear engine

(76) Inventor: Jesse Wayne Blenn, Elba, AL (US)

Correspondence Address: Jesse W. Blenn, 5198 Hwy 84, Elba, AL, 36323, US

(21) Appl. No.: 11/096,535

(22) Filed: Mar. 31, 2005

(51) Int. Cl. F01B 3/00; F16J 1/24

(52) U.S. Cl. 123/45 R

(57) ABSTRACT

An improved combustion engine, compressor, pump, or fluid driven motor in single cylinder (20 of FIG. 1) or multiple cylinder (20 of FIG. 13), versions wherein a normally cylindrical rotor (50) external to drive or driven bearings (64, 65, 65A, 65B), has a patterned cam track (between 52 and 53) for transforming the piston (32) linear reciprocating motion to rotary motion. Two cam tracks (52, 53) can be offset coaxially to allow for continuous unidirectional rotation of said bearings.

### CROSS-REFERENCE TO RELATED APPLICATIONS

This application claims the benefit of PPA Ser. No. 60/437,875, filed 2003 Jan. 3

### FEDERALLY SPONSORED RESEARCH

Not Applicable

### SEQUENCE LISTING

Not Applicable

### FIELD OF THE INVENTION

This invention relates to combustion engines primarily; and to pumps, compressors, and fluid driven motors secondarily.

### BACKGROUND OF THE INVENTION—THE PRIOR ART

Internal combustion engines are used in enormous numbers as a means of converting combustible fuel energy into rotary mechanical motion useful for a multitude of industrial and transportation tasks. These have become almost universally s as one or more units of a piston reciprocating in a cylinder where combustion takes place, the reciprocating motion of the piston being converted to rotary output motion by means of a connecting rod and crankshaft. In the earliest days, before 1900, this system was well adapted as a replacement for stationary steam engines, after which it was patterned, being slow, heavy, and easily repairable by local blacksmiths.

After 1900 came the advent of the mass-produced automobile and motorcycle and the new sports of racing these. With these incentives, and through monumental amounts of both trial and error and modern technology, the crankshaft engine has gradually developed surprising reliability, efficiency, and light weight. Yet, it is clear that it is still NOT an optimum arrangement, especially as single cylinder units and for two-stroke use. Standard connecting rod crankshaft engines suffer from numerous disadvantages and limitations:

(a) Standard engines have excessive vibration, especially as single cylinder units. The piston as it accelerates and decelerates creates reciprocating inertia forces, which cannot be balanced by the rotary motion of crankshaft counterweights. Such counterweights normally balance near 50% of reciprocating weight, but add vibration in other directions. Vibration of small engines contribute to operator fatigue, noise levels, short life span, and various and often unpredictable maintenance problems. Due to vibration problems, drive engines often are isolated from the load they drive, meaning a larger and less efficient system than integral construction would be.

(b) Heavy inertia-storage flywheels are added to smooth out vibrations and allow smooth running at lower speeds, especially in the case of Diesel (compression ignition) types. Also crankshafts are often built with added weight for flywheel effect and torsional stiffness, but as energy storage varies as the square of the distance from center of rotation, this added weight near the center of rotation is far from the optimum location, as the rim of a flywheel would be. Together these add to engine weight, inefficient use of this weight, cost, size, and complexity.

(c) In spite of the fact that a large diameter tubular shaft is the most efficient for rigidity and power transmission, an engines due to their configuration transmit power out of a closed crankcase by a sealed small diameter shaft, and then must attach a larger diameter power output hub. This entails splines, keyways, cutting threads, etc. Generally another separate component is also attached for fan, ignition, starter mechanism, accessory drive, etc. Ts results in added weight and s machining, with oil seals and added parts at both ends of the crankshaft.

(d) In crankshaft engines operating with a vertical output shaft, vibration due to inherent imbalance is transmitted horizontally, adding to machine operator discomfort and maintenance problems, including lubricating oil leakage.

(e) Crankshaft engines for industrial use with a single cylinder seldom produce more than 15 horsepower, due to vibration problems as size increases. Yet efficient multi-cylinder engines of 50 or even over 100 horsepower per cylinder are common, showing that with less vibration larger single cylinder engines would be viable, with great advantages of simplicity and economy over small multi-cylinder units.

(f) Where smooth operation is a concern multiple cylinders—three or more—are added to try to balance out and thus partially solve this vibration problem, at an expense and complexity uneconomical for small power needs. Also, adding additional cylinders contributes to additional harmonic vibrations which can lead to fatigue failure and must be carefully tested and analyzed, leading to longer development times and sometimes operating restrictions, as in the case of aircraft engines.

(g) Crankshaft engine piston speed variations are inappropriate. With the connecting rod and crankshaft system piston speed varies between top and bottom phases of the stroke, and is actually fastest near the top, when a slower speed would be advantageous to allow time for more complete combustion and higher effective expansion rates. Conversely, piston speed is slowest near the bottom of the stroke, with no useful effect. The Bourke two-stroke engine of the 1950's overcame these drawbacks with the use of a scotch yoke drive to the crankshaft, but could never solve vibration problems. Other methods have been proposed, but all involving additional complexity, weight, and manufacturing cost.

(h) The connecting rod-crankshaft system has high friction due to side thirst on the piston during most of the stroke. This causes friction, heat, and wear, reducing efficiency and the useful life of the lubricating oil and engine itself. Also, the piston skirt needed to carry this thrust adds to piston weight and engine height.

(i) Crankshaft engines have developed into high-speed machines, giving more power to weight with smaller sizes. This, though, requires more gearing to reduce these speeds to those usable in practice, especially in transportation. At the same time some speeds are set within narrow limits, such as lawn mower blade speeds, and that of generators to give the necessary output frequencies, etc. To use lighter, higher-speed engines a reduction drive would be necessary for such uses, at a cost not compatible with the small engine market. Thus, despite many advances in high-speed multi-cylinder engines, the technology of small engines is virtually stagnant due to speed as well as cost restrictions.

(j) Crankshaft four-stroke engines require a separate camshaft operating at half crankshaft speed to drive valve gear. This requires two precision cut gears or toothed pulleys and belts, and entails extra parts, bearings, weight, and attention to timing and alignment during assembly and repair.

(k) Crankshaft four-stroke engines depend on a lubrication system that requires a pressure pump and stable horizontal orientation. This limits or denies their use in inclined and inverted operation, as in chain saws and other power tools, and requires added systems and complexity to allow use in aerobatic airplanes.

(l) Crankshaft four-stroke engines require a volume of oil for adequate lubrication, cooling, and consumption, which adds to engine weight with no mechanical benefit, putting them at a weight disadvantage compared to two-stroke engines. Additionally, if water-cooled these engines require a separate and complex system including radiator, pump, external hoses, etc. with weight penalties, maintenance problems, and no mechanical advantage.

(m) Crankshaft engines are very unsymmetrical, especially the four-stroke types, leading to high costs in engineering and manufacture. Due to offset components such as the camshaft and its gearing, the oil pump, cylinder placement at ninety degrees to crankshaft axis, etc., the cross-sectional area is large, leading to high drag in aeronautical applications, and limiting use in circular spaces. Due to lack of axial symmetry, the majority of engine components must be intricate castings or forgings, and thus they do not lend themselves to rapid or easily automated manufacture from extrusions or flat stock components. This also makes the setup for manufacture, and model changes later, both slow and costly, restricting both the size and location of engine manufacturers to generally large ones in developed countries. At the same time repair parts tend to be specialized and costly. This has led to high repair costs, trade deficits, and lack of self-sufficiency in smaller and poorer countries.

(n) In crankshaft two-stroke cycle engines the combined volume of both crankcase and variable under-piston volume is used as a pump to ingest the intake mixture of air, fuel, and oil. The varying movement of the connecting rod would make sealing the area below the piston from the rest of the crankcase cavity very difficult. If this were practical it could be used to advantage for simple supercharging in both two and four-stoke engines, air compression, direct drive to reciprocating pumps, etc.

(o) In crankshaft two-stroke engines the use of the crankcase for intake pumping precludes the use of more reliable oil-lubricated power output bearings in a separate cavity.

(p) Crankshaft two-stoke engines generally suffer from the fact that intake transfer and exhaust ports are timed only by piston movement, allowing fuel m to exit through open exhaust ports, exhaust gases to be intermixed with incoming fuel mixture causing rough idle, etc. This causes high rates of fuel consumption and air pollution. A few attempts have been made at varying exhaust port timing, but with additional complexity and cost. The addition of bulky and expensive “tuned” expansion chamber exhaust systems has been used to partially offset this problem. However they are effective only during a small range at high rpm, increasing power but not reducing pollution at other speeds or rough idle. More stringent air pollution controls and higher fuel prices will increasingly limit the use of standard two-stroke engines.

With modern materials, computed aided design and manufacturing, and fuel use and air pollution concerns, viable alternatives to the crankshaft engine should be investigated. Many other types of engines have been proposed, some tested, and in a few rare cases put into production, such as the Wankel rotary and the cam track Dynacam™ engine. However even these have not been optimum, especially in the areas of exhaust emissions and economy of manufacture and have had generally limited success.

While clearly much different in operation, the small, light, and low-vibration Wankel could be used in virtually every application now using piston engines. It has disadvantages, though, including:

(q) Wankel rotary engine cost of manufacture is high. The necessary optimum clearances and large flat combustion chamber areas to seal require higher cost production processes and materials. Thus, in real terms it has not been able to compete successfully with standard piston engines.

(r) Wankel rotary engine air pollution is more of a problem due to varying combustion chamber temperatures and sealing problems. Techniques used to control emissions in standard crankshaft engines are often not directly applicable to the Wankel rotary engine. These appear to worsen more with age than with standard engines.

(s) Wankel rotary engine repair services and parts are more costly and are not widely available due to few mechanics and parts manufacturers being familiar with the very different technology used.

An alternate method to the connecting rod-crank shaft and rotary engine systems of power output is the use of a reciprocating piston driving a rotary output shaft through a sinusoidal cam track driven mechanism. U.S. Pat. No. 1,052,763 (Stone & Scott, 1913) is one of many early examples of cam track single-cylinder engines. The most successful modern example is the Dynacam™ Type Certified multi-cylinder aircraft engine, shown in U.S. Pat. No. 4,492,188 (Palmer et al 1985). Past patents for this type of engine have described various arrangements whereby this motion transfer has been tried, and different component arrangements, but clearly they all have had disadvantages, including:

(t) Previous cam track engines have excessive vibration as single piston engines, caused by an imbalance of parts, even more than the connecting rod-crankshaft system with counterweights. Some patents show a second piston in line with the first for balance, examples being U.S. Pat. No. 1,613,136 (Schieffelin, 1927), U.S. Pat. No. 1,629,686 (Dreisbach 1927), U.S. Pat. No. 1,876,506 (Lee, 1932). These involve excessive added complexity, especially in the arrangement for power output, often necessitating multiple cam tracks, undesirable shaft through a combustion chamber, etc. Again in the interest of balanced operation, many patents show additional pistons added in array around the shaft, as in the Dynacam™, an early example being U.S. Pat. No. 1,065,604 (Gray, 1913). Like multi-cylinder conventional engines, these also are too complex and expensive for small power needs.

(u) Previous cam track engines have cooling complications. Some patents for single cylinder versions show a cam system within the piston itself; with no means of cooling the bearings as in U.S. Pat. No. 1,052,763 (Stone & Scott, 1913). As these would be exposed to heat from the piston, such a system would necessitate a large flow of oil for cooling and lubrication, necessitating a high capacity and power consuming oil pump, oil cooling radiator, etc., not economically practical for small engines, and never shown in the patent drawings. When multiple cylinders are used around a central shaft, space restrictions generally do not allow for air-cooling of the cylinders, and thus also require a liquid coolant pump, radiator, etc.

(v) In previous cam track engines, lubrication is either a major problem or requires a complex system. In configurations showing a spinning bearing assembly, lubricant would clearly be thrown from the bearings by centrifugal force and would need to be constantly replenished by a pump-supplied pure lubrication system. Reciprocating components may be difficult to supply or direct lubricant to, especially if using sleeve-type bearings needing internal oil pressure to operate. As mentioned, if adjacent to the hot piston or cylinder assembly, additional systems for cooling of the lubricant would also have to be provided.

(w) In previous cam track engines sizing of bearings is definitely problematic if these are within the diameter of the piston or cylinder, as shown in several patents. The high inertia and pressure loading on the piston assembly to be transferred to the output cam track require relatively large bearings, not possible in the space restrictions often shown.

(x) In previous patents of cam track engines, one or more single output rollers in a single cam track is usually shown. These are clearly subject to constant and undesirable abrupt rotation reversals, a major problem. Some show two output rollers at each location to avoid this, still with a single cam track, but need added length and complexity to achieve this, with no other advantage.

(y) In previous cam track engines, output is still generally by a small diameter shaft and a lower case equivalent to a crankcase is still needed, as well as the shaft machining and additional components mentioned above. With multi-cylinder systems complex castings and machinings are needed.

(z) In previous cam track engines, as with crankshaft engines, heavy inertia storage flywheels were often added to smooth out vibrations and allow smooth running at lower speeds. Alternately, the output shaft or sinusoidal cam may be made oversize and overweight for a similar effect, but as with a crankshaft its small radius is still not an efficient location for inertia storage.

### BACKGROUND OF THE INVENTION—OBJECTS AND ADVANTAGES

Accordingly several objects and advantages of the present invention include:

(a) to provide a single-cylinder engine which is of low vibration, with 100% balanced reciprocating forces, minimal operator fatigue, low noise levels, long life span, minimal maintenance problems, and especially adaptable to direct or integral drive of loads.

(b) to provide an engine without the necessity of added flywheel inertia for low vibration or for option using the Diesel cycle;

(c) to provide an engine with a lightweight and rigid power output attachment, without need of separate parts or machining operations;

(d) to provide a vertical-shaft engine without horizontal transmission of vibration, operator discomfort, excessive maintenance problems, and leakage of lubricant.

(e) to provide an engine capable of smoothly producing large amounts of power in a single cylinder, thus replacing multi-cylinder engines in many uses.

(f) to provide an engine which does not require the complexity of adding cylinders to achieve smooth operation;

(g) to provide an engine with a balanced piston speed for optimum combustion;

(h) to provide an engine without piston side thrust;

(i) to provide an engine with inherent speed reduction for high piston speed and low weight, adaptable to modern advances in high speed engines;

(j) to provide a four-stroke engine that does not require a separate camshaft and its drive mechanisms;

(k) to provide an engine without a gravity feed oil pump and which can thus be operated in inclined and inverted positions;

(l) to provide an engine with an effective oil lubrication system that acts as a flywheel and thus minimizes weight in both four-stroke and two-stroke versions, also adaptable as a liquid cooling system with no water, radiator, or external hosing.

(m) to provide an engine with symmetrical components of minimal axial cross-section especially suited to use in aeronautical applications and use in tubular spaces, and of easily automated and economical manufacture from stock extruded and rolled materials;

(n) to provide an engine whose under-piston volume is usable for effective supercharging or other useful work;

(o) to provide a two-stroke engine with oil-lubricated output bearings sealed from the air/fuel intake system;

(p) to provide a two-stroke engine with smooth running, minimized fuel use, and reduced harmful emissions by simple timed closing of the exhaust port;

(q) to provide an engine of simple manufacture which can compete with standard crankshaft engines in cost;

(r) to provide an engine which uses standard cylinder, piston, and valve technology for even temperature, optimum sealing, and long life; and thus can easily and effectively use emissions control methods of standard crankshaft engines;

(s) to provide an engine which uses well-proven and available piston engine technology and components for low cost manufacture, parts supply, and repair services;

(t) to provide a single-cylinder cam track engine with simple 100% balancing of piston assembly reciprocating weight for minimum vibration;

(u) to provide a cam track engine which has simple and effective oil cooling of internal components, and does not require additional liquid cooling or cooling radiators;

(v) to provide a cam track engine which has a simple and effective pressure oil lubrication system, without an oil pump;

(w) to provide a cam track engine with ample space for high capacity power output bearings;

(x) to provide a cam track engine with double output rollers to avoid rotation reversals, on the same axis, allowing double cams for increased diameter and thus flywheel effect, without increasing length.

(y) to provide a cam track engine without separate and complex stationary output bearing covers and rotary output means;

(z) to provide a cam track engine which uses the rotating cam track and existing lubricating oil most effectively as flywheel energy storage.

Further objects and advantages are to provide an improved technology for engines which are simple, smooth-running, economical, of low pollution, easily manufactured including in developing countries, especially adaptable to use of supercharging and compound operation cycles, and which allow new opportunities for further advances applicable to many other related uses such as air and refrigerant compressors, pumps, fluid driven motors and the like, at a cost competitive with present machines. Still further objects and advantages will become apparent from a consideration of the following drawings and description.

### SUMMARY

In accordance with the present invention, an external rotary drum (rotor) system replaces the connecting rod, crankcase, and crankshaft of a conventional piston engine. This converts the reciprocating motion of the piston or pistons to rotary motion of the rotor, and incorporates multiple improvements over the prior art. An integral lubrication and cooling system captures the dynamic pressure of lubricant spinning with the rotor, providing a source of pressurized lubricant and/or coolant, enhanced flywheel effect, and operational advantages. To eliminate vibration of single cylinder versions, a balancer of weight equal to the piston assembly reciprocates on the same axis as the piston assembly, in opposite directions.

### DRAWINGS—DESCRIPTION OF FIGURES

In the drawings, closely related figures have the same number but different alphabetic suffixes.

FIG. 1 is an isometric view of the preferred embodiment of the invention as adapted to propeller aircraft use.

FIG. 2 is an isometric view showing the main stationary and reciprocating components of the engine.

FIGS. 3A to 3C are isometric views showing the piston and balancer assemblies and their manner of assembly.

FIG. 4 is an isometric view showing the main rotary components.

FIG. 5 is a graphical representation of the cam track output means of FIG. 4.

FIG. 6A is a side cross-sectional view of the rotor assembly 50 of FIG. 2.

FIG. 6B is a side cross-sectional view of the stator 44 of FIG. 2.

FIG. 6C is an end cross-sectional view of the assembled rotor and stator of FIG.1.

FIG. 7A is a partial side cross-sectional view of the assembled rotor and stator of FIG. 1, showing details of the lubrication system.

FIG. 7B is an end cross-sectional view of the assembled rotor and stator of FIG. 1, showing details of the lubrication system.

FIG. 7C is a partial side cross-sectional view of the stator 44 of FIG. 6B, showing details of the lubrication system.

FIG. 8 is an alternate embodiment using a second piston in the same cylinder.

FIG. 9 is a schematic representation of the operation of a compound four-stroke cycle engine using the alternate embodiment of FIG. 8.

FIG. 10 is an alternate embodiment using a second piston in a second cylinder.

FIG. 11 is an alternate embodiment bearing arrangement to reduce diameter.

FIG. 12 is an alternate embodiment showing an exhaust port shield for two-stroke engines.

FIG. 13 is an alternate embodiment showing a multiple cylinder version.

### DRAWINGS—REFERENCE NUMERALS

| | |
|---|---|
| 20 cylinder assembly | 22 cylinder |
| 23 muffler | 24 valve cover |
| 25 camshaft | 25A intake valve cam |
| 25B exhaust valve cam | 26 cam follower box |
| 27 pushrod tubes | 28A intake |
| 28B exhaust | 29 exhaust port shield |
| 30 piston/balancer assembly | 32 piston |
| 33 balancer | 34 cross tube |
| 35 cross member | 36 piston tube |
| 37 dynamic oil pickup | 39 bearing retainer |
| 40 stator assembly | 42 cylinder mount studs |
| 43 stator drive slots | 44 stator |
| 46 thrust plate | 49 thrust plate bolts |
| 50 rotor assembly | 51 rotor shaft |
| 52 inner cam plate | 53 outer cam plate |
| 54 bearing surface | 55 drum |
| 56 end plate | 57 inspection plug |
| 58 ignition magnets | 59 rotor bolts |
| 63 balancer bearing sleeve | 64 stator drive slot bearing |
| 65 cam plate bearing | 65A inner cam plate bearing |
| 65B outer cam plate bearing | 73 oil passage in piston/balancer |
| 74 oil passages in stator | 75 oil orifice to rotor bearing |
| 76 oil orifice to cam plate bearings | 77 lubricating oil |
| 84 ignition coil | 88 spark plug |
| 90 engine mount | 92 engine mount bolts |
| 95 propeller | 98 spinner |
| 99 propeller bolts | |

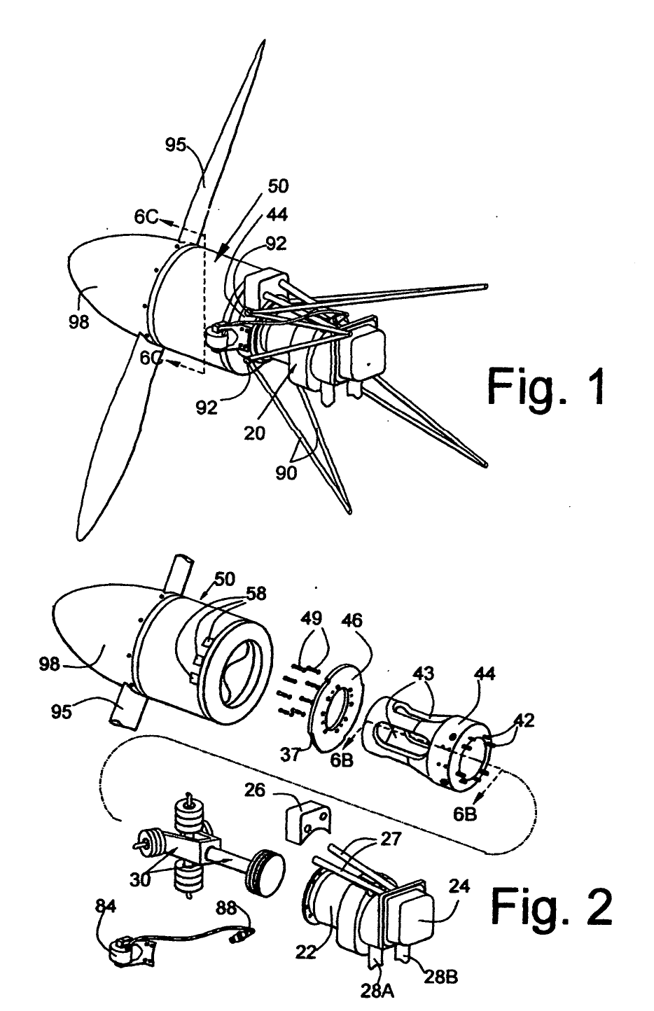

### PREFERRED EMBODIMENT DESCRLPTION AND OPERATION—FIGS. 1-7C

FIG. 1 depicts the preferred embodiment of the present invention, an aircraft engine. A cylinder assembly 20 is assembled to a stator 44, supported on an engine mount 90 by means of engine mount bolts 92. A rotor assembly 50 spins coaxially with the longitudinal axis of the cylinder assembly, imparting rotary motion to a propeller 95, over the central portion of which is mounted a streamlined spinner 98.

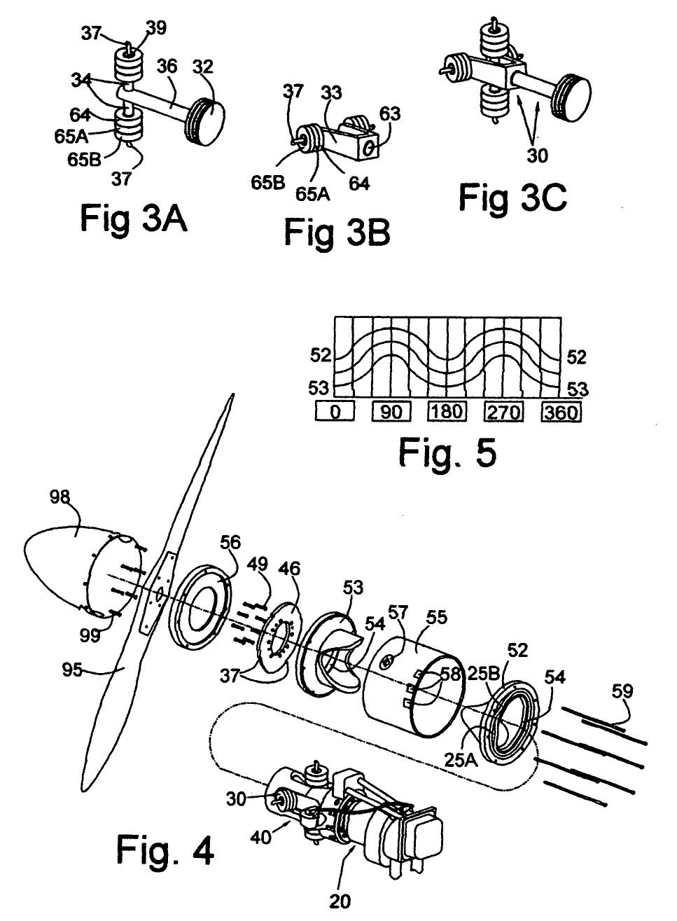

FIG. 2 shows the engine in partially exploded form, with stationary and reciprocating components clarified. The cylinder assembly (20 of FIG. 1) comprises a cylinder 22 with a valve cover 24, and an intake 28A and exhaust 28B, to which may be attached to prior art carburetion and exhaust systems (not shown). A cam follower box 26 houses prior art valve actuation means, which drive prior art intake and exhaust valves through pushrods housed in pushrod tubes 27. Ignition is provided by an ignition coil 84 excited by rotating ignition magnets 58 on the rotor assembly 50, supplying energy to a spark plug 88. A piston/balancer assembly 30 is further described in FIGS. 3A to 3C. Cylinder mount studs 42 attach the cylinder 22 to the stator 44, which incorporates drive slots 43. A thrust plate 46 attaches to the stator 44 by means of thrust plate bolts 49. The thrust plate 46 includes dynamic oil pickups 37, in the form of drilled passages. The thrust plate 46 is assembled between components of the rotor assembly 50, thus locating the rotor assembly in position to rotate upon the stator 44. The propeller 95 attaches to the rotor 50 and is covered by the spinner 98.

FIG. 3A shows a piston 32 mounted upon a piston tube 36, integral with a cross tube 34, upon each end of which mount a stator drive slot bearing 64, an inner cam plate bearing 65A, and an outer cam plate bearing 65B, secured by bearing retainers 39. A dynamic oil pickup 37 protrudes from the bearing retainer 39 on each end of the cross tube 34, and serves to capture lubricating oil under pressure which is led to the interior of the cross tube 34 for distribution as suitable to lubricate and cool the various mechanical components, as will be better understood by reference to FIG. 7B. FIG. 3B shows a balancer 33 which in operation is of essentially the same weight as the piston 32 of FIG. 3A. The balancer 33 includes a balancer bearing sleeve 63 which is free to reciprocate upon the piston tube 36 of FIG. 3A. The balancer includes stator drive slot bearings 64 and inner and outer cam plate bearings 65A and 65B in the same positions as on the piston cross tube, and may also include dynamic oil pickups 37 as shown. As shown in FIG. 3C, the piston/balancer assembly 30 consists of the slideable joining of the two assemblies of FIGS. 3A and 3B.

FIG. 4 shows the engine in exploded form with the main rotating components clarified. The streamlined spinner 98 covers the attachment area of the propeller 95, where it is attached to an end plate 56 by means of propeller bolts 99. Rotor bolts 59 are used to rigidly assemble an inner cam plate 52, a drum 55, and an outer cam plate 53 to the end plate 56 to form a torsionally rigid unit. On assembly the thrust plate 46 is sandwiched between the end plate 56 and the outer cam plate 53 with a small clearance allowing rotation, and is rigidly attached by the thrust plate bolts 49 to the stator assembly 40, thus fixing the longitudinal position of the rotor assembly (50 of FIG. 1) and carrying rotor end loads. The thrust plate 46 may include notches as the four shown to build dynamic pressure for entry of lubricating oil into passages within the thrust plate 46, as further seen in FIG. 7C.

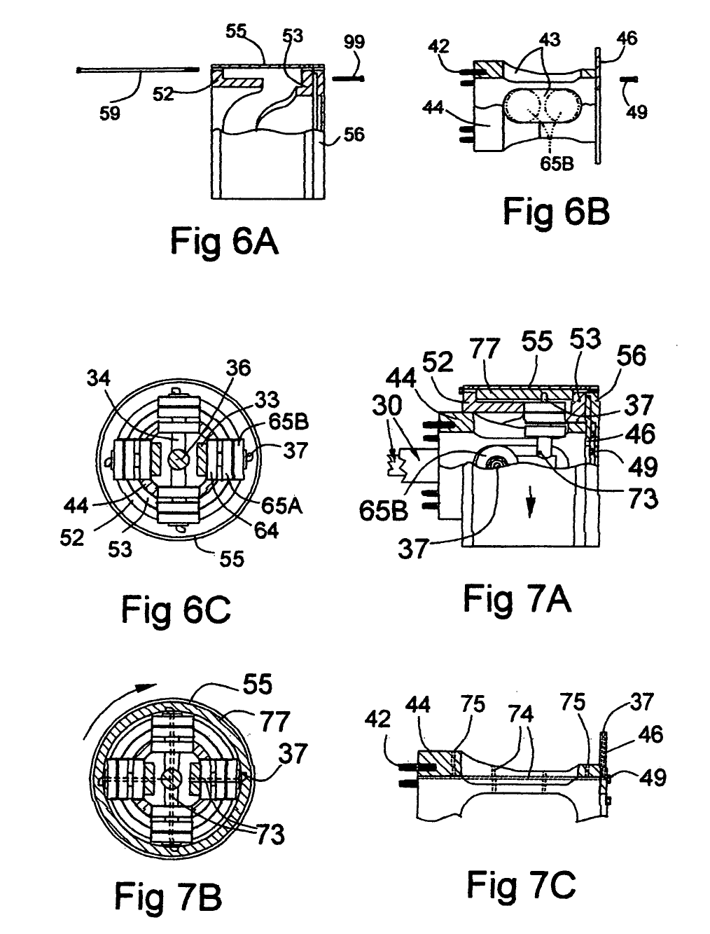

One or more inspection plugs 57 allow inspection of bearings, changing of oil, etc. Indexing notches or pins (not shown) positively locate the drum 55 in position on the cam plates 52 and 53, with oil retained by rubber O-ring or similar means. On assembly the cam plates 52 and 53 form an open bearing groove of sinusoidal shape, as will be graphically descried in FIG. 5 and seen in FIG. 6A. On assembly the bearings of the piston/balancer assembly 30 protruding from the stator assembly 40 fit within the groove formed between the cam plates 52 and 53, thus locating the piston and balancer and controlling their relative reciprocal motion. Cam plates 52 and 53 include a bearing surface 54, allowing their rotation on the stator assembly 40 with minimum friction.

On the inner cam plate 52 is located an intake cam 25A and an exhaust cam 25B which drive the intake and exhaust valves through a pushrod system, these being of standard prior art design, through prior art roller tappets (not shown). Valves may be adjusted automatically by hydraulic lifters operating from the pressure oil system, or manually if so designed. It will be noted that the pushrod tube (27 of FIG. 2) for the exhaust valve is raised slightly to align with the exhaust cam 25B. These combined features allow the flexibility and advantages of using an off-the-shelf air cylinder 20 in most aircraft applications. When using purpose-built cylinders, it will be appreciated that a single cam will often suffice, with the tappets and pushrods located near 110 degrees rotation apart for correct valve timing. Also, using this general arrangement with or without rocker arms, four valves per cylinder, true hemispherical combustion chambers with exhaust on one side and intake on the other, L-head (“flathead”) or other variations can easily be accommodated.

FIG. 5 is a graphical representation of the movements imparted to the piston and balancer bearings 65A and 65B of FIGS. 3A and 3B by the inner and outer cam plates, shown over 360 degrees of rotation. These resemble a mathematical or electrical sine wave. Alternately, it can be understood to represent the pattern cut into the inner and outer cam plates 52 and 53 of FIG. 4, as if the cylindrical form of these were “unrolled”. When the upper curve 52-52 of FIG. 4 represents the inner cam plate 52 and the lower curve53-53 represents the outer cam plate 53, it can be seen that the piston bearings 65A and 65B of FIG. 3A would operate at 180 degrees apart on the graph, with the vertical variations of the centerline each 90 degrees representing the stroke of the piston, four strokes per 360 degree rotation. The counterpart bearings for the balancer of FIG. 3B would also operate at 180 degrees apart on the graph, at a 90 degree lateral angular distance from those of the piston, assuring a reciprocal movement exactly equal and opposite that of the piston, with fully balanced reciprocal forces.

FIG. 6A shows the rotor assembly 50 of FIG. 2 in cross-section, whereby the assembly of the four components inner cam plate 52, drum 55, outer cam plate 53, and end plate 56, by means of the rotor bolts 59 (one shown) can be seen. Also shown are the propeller mount bolts 99 (one shown) which attach the propeller (95 of FIG. 1) to the end plate 56. On assembly as shown, it can be seen that a groove is provided between outer cam plate 53 and end plate 56, wherein the thrust plate (46 of FIG. 2) is to be located.

FIG. 6B shows in its upper portion the stator 44 in side cross-sectional view where the locations of the stator drive slots 43 may be seen. The thrust plate 46 is shown in its location on the stator 44, to be attached by thrust plate bolts 49 (one shown). Cylinder mount studs 42 are shown, as well as the alternating locations (dotted lines) of an outer cam plate bearing 65 protruding beyond the stator drive slot at top and bottom of its stroke.

FIG. 6C shows the components of FIGS. 6A and 6B assembled with those of FIG. 3C in end cross-sectional view, as referred to in FIG. 1. The piston rod 36 by means of the cross tube 34 and the balancer 33 include sets of bearings 64, 65A, and 65B. Dynamic oil pickups 37 are provided, which operation will be better understood by reference to FIG. 7B. The stator 44 shows in cross-section the arrangement whereby the stator drive slot bearings 64 are located and output torque is thus transmitted to the stator. The assembly of outer cam plate 53, inner cam plate 52, and drum 55 rotates as a unit upon the stator 44, while the piston and balancer and assembled bearings reciprocate but do not rotate. The location of the inner cam plate 52 is shown for better understanding of its relative position, though it would not actually be visible if looking toward the propeller end of the engine.

From FIGS. 6A and 6B it can be seen that the drive slot bearing 64 is subject to a relatively low speed alternating rotation. The cam plate bearings 65A and 65B are subject to high speed rotation, and align with the inner and outer cam plates 52 and 53 at different radial distances from the center axis, providing two separate but coaxial cam surfaces for bearing contact, thus eliminating bearing rotation reversals with reversing reciprocal forces on the bearings as in most prior art patents. The orientation of the balancer bearings at an angular spacing of 90 degrees from those of the piston bearings assures a reciprocal movement exactly opposite that of the piston, as shown graphically in FIG. 5, thus fully balancing the reciprocal inertia forces of the piston for smoothness of operation.

FIG. 7A shows the assembled components of FIGS. 6A through 6C in partial cross sectional view, and includes details of the lubrication system. The operating location of the piston and balancer 30 is more clearly shown, with the outer cam plate bearing 65B at the top of its stroke, at which time the piston (32 of FIG. 3A) is at the bottom of its stroke. The assembled location of the thrust plate 46 and its thrust plate bolts 49 are shown. It will be noted that the assembled components including the inner cam plate 52, drum 55, outer cam plate 53, and end plate 56 form a hollow chamber, which revolves on the stator 44 in the direction shown by the downward pointing arrow. In operation this formed chamber holds a volume of lubricating oil 77, which rotates or spins with the assembly. The dynamic oil pickups 37, which here reciprocate but do not revolve, thus capture pressurized oil from the volume of spinning lubricating oil 77, from which it is conducted by dynamic pressure to within the piston or balancer assembly 30 to be distributed where needed, as for example by an oil passage in the piston or balancer 73.

FIG. 7B shows the assembled rotor and stator cross-section of FIG. 6C, and includes added details of the lubrication system. Here lubricating oil 77 spins clockwise as shown by the external arrow together will the drum 55, and is captured by the dynamic oil pickups 37, from which it is conducted inward by oil passages in the piston/balancer 73, being available at any point to lubricate bearings, piston, etc.

FIG. 7C shows other details of the lubrication system, where a partial cut-away of the assembled stator 44 with thrust plate 46 attached by thrust plate bolts 49 shows by dotted lines oil passages in stator 74 which supply pressurized oil for oil orfices to rotor bearings 75, or any other need for oil, as for example to valve components, oil pressure gauge sender, external oil filter, etc. The periphery of thrust plate 46 may be notched as visible in FIG. 4 or on either side (not shown) to create positive dynamic pressure at the dynamic oil pickups 37.

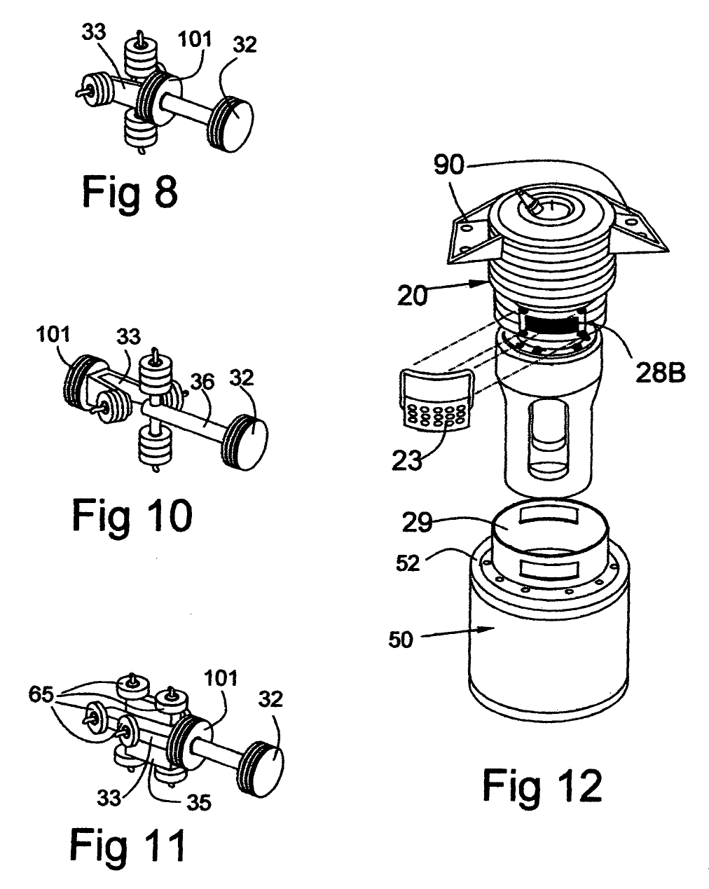

### ALTERNATE EMBODIMENTS DESCRIPTION AND OPERATION—FIGS. 8-12

FIG. 8 is an alternate embodiment of the assembled piston/balancer 30 of FIG. 3C, where the balancer 33 includes a secondary piston 101 which operates coaxially in the same cylinder as the fist or combustion piston 32. It will be noted that the effective stroke of the cylinder volume between the two pistons 32 and 32 is twice the stroke of the preferred embodiment, and can be achieved by simply extending the cylinder bore of the cylinder (22 of FIG. 2) further into the stator (44 of FIG. 2), with a minor increase in engine length and with little added complexity.

This embodiment can be used to supercharge the intake transferred to the combustion chamber above piston 32, for substantially increased power output or, as in aircraft, full rated power up to high altitudes. Also by this means in both two stroke and four stroke engines the rotor assembly and its bearings are permitted to operate in a permanent oil-lubricated environment with a very minimum of dilution or contamination from combustion gases blown by the piston rings.

Given the location of the rotating inner cam plate (52 of FIG. 4) adjacent to the second piston, a rotary valve system similar to that used on many two-stroke cycle engines may be integral with, attached to, or driven directly by the cam plate. This could control flow into and from the resulting inter-piston chamber and allow its transfer into the combustion chamber at the appropriate time. Also a prior art reed valve system could be used. For two-stroke cycle use a theoretical 100% (twice combustion chamber volume per cycle) supercharging is thus provided, and for four-stroke use a theoretical 300% (four times combustion chamber volume per cycle) supercharge is provided. Actual effect will be less, and a four-stroke system would include a charge storage chamber, doubling as intercooler, to hold that charge compressed during the power stoke of the combustion piston, the total charge to be transferred on the intake stroke of the combustion piston.

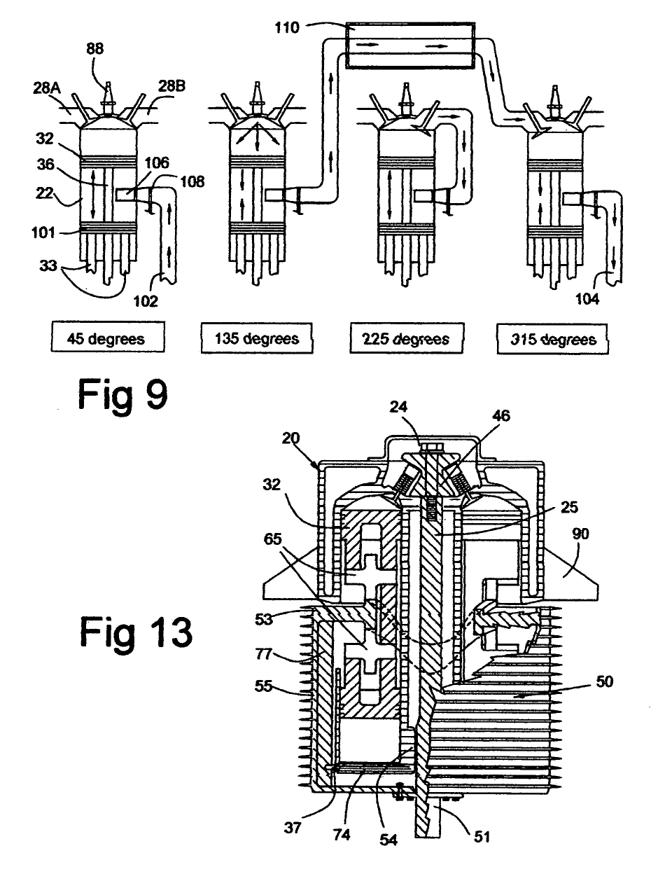

FIG. 9 is a schematic representation of how the embodiment of FIG. 8 can be applied to the operation of a compound four-stroke cycle engine. Using the beginning of air inlet into the engine at bottom center of the piston 32 as 0 degrees, both pistons are shown at a mid-position of their four strokes, at the different stages of 45, 135, 225, and 315 degrees of rotor rotation past bottom center. The combustion piston 32 is mounted on piston tube 36, by which it is driven from the cam means best illustrated in FIG. 7A. A secondary piston 101, as also shown in FIG. 8, reciprocates in the same cylinder 22 with equal and opposite movement imparted by balancer 33, to which it is attached. A combustion chamber above the piston 32 is filled by an intake 28A and emptied by an exhaust 28B, through conventional valves. A primary intake 102 is the first inlet for air or air/fuel mix. A secondary exhaust 104 serves as the final outlet for burnt gases. The four manifolds or passages shown in the four schematic representations are timed in their interconnection with an inter-piston port 106 by means of a rotary valve 108, driven from or attached to the inner cam plate 52 of FIG. 4. By this port 106 or multiple similar ones the inter-piston volume is both filled and emptied as the pistons 32 and 101 move apart and together. An intercooler 110 and associated manifold serves to cool and store pressurized charge for the coming intake into the combustion chamber.

At 45 degrees past bottom center, the gases above piton 32 are being compressed, while a fresh volume of gases is being admitted through the port 106, as timed by the rotary valve 108. At 135 degrees, ignition (or injection of compression ignition versions) has occurred and the piston 32 is traveling downward, producing power. A portion of the power produced is used directly by piston 32 and indirectly by piston 101 to compress the new volume of intake 2:1 and force it to the intercooler 110 and associated manifold for storage and cooling. The use of power at this time helps to smooth out the output torque fluctuations experienced by a conventional engine. At 225 degrees, the burnt gases above the piston 32 are being admitted into the inter-piston space where they undergo an additional 1:2 expansion for higher efficiency, expansive cooling, and additional power output. At 315 degrees the fresh intake at near 2:1 preliminary compression is being admitted into the combustion chamber, where they help to force the expanded exhaust gases out the secondary exhaust 104. It will be seen that power is transferred to the rotor on three of the four strokes: at 135 degrees by combustion above piston 32, at 225 degrees by expansion between pistons 32 and 101, and at 315 degrees by admission of the pressurized charge stored in the intercooler 110.

From this explanation of the generally prior art compound engine, it can be appreciated that a very advantageous arrangement is provided by the present invention for the simple and efficient functioning of a compound four-stroke engine. It should be noted that due to the near-total absence of side forces on the piston 32, and the fact that the piston can be easily cooled by any desired internal flow of cooling oil as provided in FIG. 7B, this alternate embodiment holds the most promise of any engine design to date to allow the practical use of an unlubricated ceramic or low-friction coated piston (32) and achieve for the first time a simple and efficient compound four-woke engine. Also it is noteworthy that because of the lower internal pressures acting upon the lower portion of the cylinder 22 in which piston 101 operates, it is conducive to the enlargement of the diameter of this piston for additional supercharge and/or expansion effect, beyond the 2:1 and 1:2 mentioned, likely near a 3:1 ratio being optimum.

FIG. 10 shows a second piston embodiment wherein the secondary piston 101 is attached to the balancer 33 to operate in a second cylinder (not shown) at the opposite end of the engine from the first piston 32, attached to its piston tube 36. It can be appreciated that under some situations this embodiment can be advantageous, as for example where the secondary piston 101 is used directly as an air compressor, or where a small diameter high pressure pump piston replaces the secondary piston 101.

Several other combination arrangements and embodiments not shown are possible. For example extension of both the piston rod 36—with attached piston 32—and the balancer 33—with attached piston 101—in both directions, giving a supercharged two-stroke or four stroke, or compound four-stroke, engine driving a compound compressor or double-acting pump at the end opposite the combustion chamber, without increasing the number of moving parts. Also, by varying the relative diameters between pistons 32 and 101 any desired compound ratios may be obtained.

The mechanism described can also be used as a single or double-ended simple or compound compressor or pump driven by an outside power source (electrical or by belts), with three moving parts plus bearings. When the secondary piston 101 is not desired, for simplicity a cylindrical cross pin of weight equal to the piston can replace the balancers shown, and operate with clearance in a slot in a single or two-ended piston assembly, of a stretched letter “O” shape. Clearly an electrical generator or motor rotor can be incorporated integral with the rotor for compact low-vibration generator or compressor units, integral engine driven or electric powered. Further, a combination of both a generator rotor and compressor pistons can be driven integral with the same engine (gasoline, Diesel, two stoke, four-stroke, compound or surged) for a universal field power system, with great economy of size, weight, cost and practicality.

FIG. 11 shows an alternate embodiment to reduce rotor diameter and eliminate the stator drive slot bearings (64 of FIG. 3A). This is shown as a twin piston version with combustion piston 32 and secondary piston 101. In this embodiment cam plate bearings 65 are spaced longitudinally on an extended balancer 33, and a cross member 35, which replaces the cross tube 34 of FIG. 3A. These extended generally flat surfaces reciprocate in slots in the stator relatively narrower than the bearings 65, thus allowing a large flat sliding bearing area and a smaller diameter stator as compared to the preferred embodiment, without losing strength. The bearings 65 in operation operate upon the two surfaces of a single cam track projecting internally from the rotor, as can best be appreciated by reference to FIG. 13, a multi-cylinder version which also uses a single cam track (53 of FIG. 13) projecting inward from a drum (55 of FIG. 13).

It will be seen that for the same rotational speed of the bearings 65, the smaller diameter allowed by the embodiment of FIG. 11 will allow higher revolutions of the rotor. This higher speed will compensate for the reduced flywheel effect of the reduced diameter. The reduced diameters will be conducive to more economical fabrication and to output speeds closer to those of conventional small two-stroke engines, while keeping most of the advantages of the invention, such as permanent oiling of the bearings, inherent reduction, supercharging, etc. Due to more relative stiffness left in the wall of the stator, the slots can be extended to the end of the stator for ease of assembly, then fixed by the thrust plate, etc. Further variations for ease of manufacture yet with similar operation are possible.

FIG. 12 shows one alternate embodiment using an exhaust port shield for a two-stroke engine. Piston, balancer, and bearing components are here omitted. Engine mounts 90 supports a cylinder assembly 20 for vertical operation. A rotor assembly 50 includes an inner cam plate 52, to which is attached an exhaust port shield 29. On assembly the port shield 29 aligns with the exhaust 28B. As the rotor 50 rotates the cutouts in the port shield 29 align with the exhaust to cover it at a time when the internal ports (not shown) are still uncovered by the piston (32 of FIG. 3A). As shown the shield 29 operates in a slot in the muffler 23. The exhaust 28B opens internally by means of prior art piston timed ports soon enough to allow efficient expelling of burnt gases, yet closes externally by the shield 29 soon enough to keep the fresh charge of air and fuel from exiting out the muffler 23, thus increasing power and fuel economy, and reducing pollution due to unburnt gases. Alternately the shield may be external to the muffler, operate horizontally or at an angle, be only a portion of a cylinder or disk, or be driven indirectly from the cam plate 52.

In FIG. 13, the main features of my invention are applied to a multiple cylinder version. Here a cylinder assembly 20 is supported by motor mounts 90 and carries multiple double-ended pistons 32 reciprocating parallel to a rotor 50. A camshaft 25 carries the rotor, supported by a bearing surface 54, with axial thrust carried by a thrust plate 46, here with an integral cam for valve operation and covered by a valve cover 24. The pistons 32 are elongated and double-ended to include a lower compression chamber opposite the combustion chamber shown at the top. By means of two cam plate bearings each, the pistons engage an outer cam plate 53, whose working surface contour is shown by hidden lines. A drum 55 supports the cam plate 53 and encloses a supply of lubricating oil 77, which spins with the assembly of drum 55, cam plate 53, and cam shaft 25.

Using a minimum of three pistons, the embodiment shown eliminates the need for a balancer (33 of FIG. 3B). Four pistons is likely optimum, leaving room for manifolds for intake and transfer to and from the bottom of the piston, prior art rotary or reed valving means for this, etc. Unlike the embodiments of FIGS. 8 through 11 there is not an enhanced supercharge effect from an additional secondary piston (101 of FIG. 8) operating coaxial with the piston 32, but for two stoke use a higher ratio than standard engines is still achieved, and for four-stroke cycle a 100% supercharge is still obtained A larger diameter of the lower (supercharge) portion of the piston 32 can give a greater supercharge if desired. Side thrust from torque is carried by sides of the piston to the cylinder assembly 20, and from there as torque to the engine mounts 90. As the bearing 54 is of the relatively small diameter of the camshaft 25, frictional losses are minimized and manufacture, assembly, and maintenance are simplified. Lubricating and cooling oil is captured by a dynamic oil pickup 37 and thereby conducted by an oil passage in the stator 74 to be used where necessary. With multiple cylinders, multiple such dynamic oil pickups 37 are allowed and may be located between the cylinders, including in positions higher than that shown.

It can be seen that using multiple pistons as shown here and in the prior art, such as U.S. Pat. No. 2,983,264 (Herrmann 1961), air-cooling is problematic due to space limitations, and water-cooling is thus normally proposed. It would be advantageous to use the lubricating oil for cooling also and eliminate a water cooling system, but as the heat conduction properties of oil are about half that of water this becomes bulky, heavy, and impractical with the prior art. With the embodiment of FIG. 13, the drum 55 is a large external rotating surface which can be easily cooled by forced air flow, which effect is enhanced by the addition of cooling fins integral with the drum as shown. Using this system an oil-based cooling system is provided which is integral with the engine, needs no external hosing or radiators, does not need to be pressurized or subject to leaks or added maintenance, and which uses an expanded system of dynamic oil pickups 37 to eliminate the need for a mechanical coolant pump.

The camshaft may include an integral extension in the form of rotor shaft 51 to locate or drive external components, while large diameter components, as the generator/motor for a hybrid gasoline/electric automobile may be mounted directly and independently to the rotor assembly 50. For automobile use the engine can be easily canted at an angle if desired for lower height, with belt-driven accessories driven by an extension of the camshaft. Thus both the independent and combined features of the present invention greatly aid the practicality, simplicity, and viability of multiple-cylinder cam track engines.

### CONCLUSION, RAMIFICATIONS, AND SCOPE

From the description above, the many advantages of my optimized linear engine become evident, including:

(a) It is a simple engine achieving a built in reduction, cam drive, power output attachment, and pressure lubrication and cooling system with no additional parts.

(b) It is an efficient engine by reducing or eliminating friction losses and improving combustion conditions.

(c) It is a lightweight engine due to optimum location and use of components.

(d) It is a powerful engine due to built-in supercharging and inherent high speed.

(e) It is an easily manufactured engine due to simple generally cylindrical components.

(f) It is of low vibration due to full dynamic balancing of reciprocating parts.

(g) It has a low risk of exhaust emission or maintenance problems due to the use of proven cylinder and valve technologies.

Although the description and operation above contains many specifications, these should not be construed as limiting the scope or applications of the invention but as merely providing illustrations of some of the present preferred embodiments of this invention. Many other variations are possible. For example, other reduction ratios of piston to rotor movement may be easily obtained by varying the number of curves in the cam track, variations of the cam track curvature may allow enhanced combustion properties, and additional features may be added which enhance operation and were difficult or impossible with the prior art. Also some features of the prior art may retained in combination with the present invention, for example lubrication of the bearings with a gasoline/oil mixture as in prior art two-stroke cycle engines, whereby the spinning oil supply is eliminated yet the other advantages are retained. Thus the scope of the invention should be determined not only by the examples given, but by the appended claims and their legal equivalents.

1. An improved mechanism usable as a combustion engine, compressor, or pump wherein reciprocating linear motion is converted to continuous rotary motion by means comprising the prior art components:
a. a cylinder or guide,
b. a piston or reciprocating component, operating in said cylinder or guide,
c. bearings or sliders mounted upon or integral with said piston or reciprocating component,
d. a fixed slotted stator guiding reciprocal movement of said piston or reciprocating component, by means of said bearings or sliders,
e. a rotor including a cam drive for engagement of said bearings or sliders, and rotating upon the extended axis of reciprocation of said piston or reciprocating component,
and wherein the improvement comprises:
f. means of mounting of said rotor external to said bearings or sliders and said stator,
whereby said rotor effectively acts as a rotating cover for said bearings or sliders and stator, with maximum flywheel effect.

2. The mechanism of claim 1 further including means for said rotor to act as an outer cover to said mechanism, whereby a fixed outer cover is eliminated and engine cooling is enhanced.

3. The mechanism of claim 1 further including means of mounting of drive or driven components directly to said rotor, whereby additional components or supports are eliminated.

4. The mechanism of claim 1 wherein said cam drive of said rotor includes two coaxial cam surfaces of different diameter, whereby said bearings of said piston or reciprocating member are not subject to rotation reversals,

5. The mechanism of claim 1 further including means for said rotor to act as a spinning lubricant or coolant reservoir, whereby flexibility of operating inclination is allowed.

6. The mechanism of claim 5 wherein said piston or reciprocating component and/or said stator or extension(s) thereof include lubricant passages to collect and distribute lubricant from said spinning lubricant reservoir, whereby a pressure lubrication system is provided.

7. An improved mechanism usable as a combustion engine, compressor, or pump wherein reciprocating linear motion is converted to continuous rotary motion by means comprising the prior art components:
a. a cylinder or guide,
b. a piston or reciprocating component, operating in said cylinder or guide,
c. bearings or sliders mounted upon or integral with said piston or reciprocating component,
d. a fixed slotted stator guiding reciprocal movement of said piston or reciprocating component, by means of said bearings or sliders,
e. a rotor including a cam drive for engagement of said bearings or sliders, and rotating upon the extended axis of reciprocation of said piston assembly or reciprocating component,
and wherein the improvement comprises the addition of:
f. a reciprocating balancing member,
g. additional stator slots angularly spaced from those guiding said bearings of said piston assembly or reciprocating component,
h. additional bearings or sliders mounted upon or integral with said balancing member for reciprocation in said additional stator slots, while engaged in said internal cam drive of said rotor,
whereby upon rotor rotation the reciprocation of said balancing member creates reciprocal inertia forces that oppose and thus cancel the reciprocal inertia forces of said piston assembly or reciprocating component, obtaining educed vibration.

8. The mechanism of claim 7, wherein said balancing member is a second piston assembly operable in the same cylinder as first said piston assembly.

9. The mechanism of claim 7, wherein said balancing member is a second piston assembly operable in a karate cylinder coaxial with the cylinder of first said piston assembly.

10. The mechanism of claim 7, further including means for said balancing member to act as a reciprocating power output, whereby other reciprocating mechanisms may be driven.

11. The mechanism of claim 7, further including means for said balancing member to collect and distribute lubricant from said spinning lubricant reservoir, whereby a pressure lubrication system is provided.

12. A mechanism comprising:
a. a spinning reservoir,
b. a liquid lubricant or coolant spinning within said reservoir,
c. non-rotating means for capturing said liquid lubricant or coolant under dynamic pressure, whereby a pressure lubrication or cooling system is provided.

13. The mechanism of claim 12, further including means for said spinning reservoir to act as an outer cover to said mechanism, whereby a fixed outer cover is eliminated and liquid lubricant or coolant cooling is enhanced.

14. The mechanism of claim 12 filter including means for direct mounting of drive or driven components, whereby additional components or supports are eliminated.

15. The mechanism of claim 12 wherein said spinning reservoir contains means for conversion of rotary to or from reciprocating motion by an internal cam drive mechanism.

16. An improved multiple cylinder engine, pump, or compressor comprising the prior art components:
a. a cylinder assembly or assemblies,
b. a rotor including a cam drive,
c. pistons reciprocable within said cylinder assembly or assemblies on an axis generally parallel to the axis of rotation of said rotor,
d. bearings or sliders mounted upon or integral with said pistons and engaged in said cam drive of said rotor, whereby reciprocating movement of said pistons coincides with rotary movement of said rotor,
and wherein the improvement comprises:
e. means for mounting of said rotor external to said included cam drive and said bearings or sliders, whereby said rotor effectively acts as a rotating cover for said cam drive and said bearings or sliders, with maximum flywheel effect.

17. The engine, pump, or compressor of claim 16, further including means for said rotor to act as a rotating outer cover to said engine, pump, or compressor, whereby a fixed outer cover is eliminated and engine cooling is enhanced.

18. The engine, pump, or compressor of claim 16, further including means of mounting of drive or driven components direct to said rotor, whereby additional components or supports are eliminated.

19. The engine, pump, or compressor of claim 16, further including means for said rotor to act as a spinning lubricant reservoir, whereby flexibility of operating inclination is allowed.

20. The engine, pump, or compressor of claim 19, further including means for said cylinder assembly or assemblies or extension(s) thereof; or said pistons or extensions thereof, to act as collectors and distributors of lubricant from said spinning reservoir, whereby a pressure lubrication system is provided.
